(19) United States
(12) Patent Application Publication
(10) Pub. No.: US 2026/0061877 A1
(43) Pub. Date: Mar. 5, 2026

(54) METHOD FOR OPTIMIZING AND CONSTRUCTING A SEGMENTAL ELECTRIFICATION SYSTEM

(71) Applicant: VOLTIFY INC., Philadelphia, PA (US)

(72) Inventor: Alon KESSEL, Ramat Gan (IL)

(21) Appl. No.: 18/822,600

(22) Filed: Sep. 3, 2024

(51) Int. Cl. B60L 53/63; B60L 53/66; B61C 17/06; B61L 25/02; B61L 27/60; B61L 27/70; H02J 3/06; H02J 3/46

(52) U.S. Cl. CPC B60L 53/63; B60L 53/66; B61C 17/06; B61L 27/60; B61L 27/70; H02J 3/06; H02J 3/46; B60L 2200/26; B61L 25/025

(57) ABSTRACT

The present invention discloses a method and an electrification system for charging a rolling stock energy storage unit while the rolling stock is in or passes through a charging segment infrastructure. In addition, the present invention further discloses of a method configured to produce an optimized microgrid plan configured to supply power to a rolling stock.

### FIELD OF THE INVENTION

The present invention is in the field of a method for optimizing and constructing a segmental electrification system.

### BACKGROUND OF THE INVENTION

Rail electrification is considered sustainable and therefor a preferable option compared to traditional train powering methods like diesel or steam engines. Rail electrification has several advantages over traditional train powering methods (a) reduces emission, (b) can use renewable energy sources, (c) higher operational efficiency (d) more energy efficient (e) less noisy.

However, the current electrification system has several significant disadvantages: (i) high cost therefore they require substantial economic justification, which is often only feasible on routes with high train volumes. Consequently, many routes with lower volumes, such as freight train routes, remain unelectrified; (ii) infrastructure challenges in isolated areas bridges and tunnels; and (iii) grid dependency and upgrades to ensure a sufficient and reliable power supply.

Although electric trains reduce emissions compared to diesel trains, the electricity they use is often generated from a mix of renewable and non-renewable sources. In addition, electrified trains depend on a continuous power supply from the grid. Any interruption or malfunction in the grid can halt train operations, leading to delays and disruptions. Furthermore, trains operating on electrified lines must have converters that convert the high voltage from the grid to a lower voltage suitable for the train's motors, adding complexity to the train's design and increasing costs.

There is an eminent need, for an alternative electrification system that can overcome the disadvantages mentioned but mainly the dependency on continuous power supply, infrastructure challenges, and optimize its operational cost, that prevent the use of electrification system.

### SUMMARY OF THE INVENTION

It is hence an object of the invention to disclose an electrification system configured to charge a rolling stock energy storage unit while in or passing through a charging segment infrastructure is characterized by:
a. segmental charging infrastructure for charging the energy storage unit of a rolling stock;
b. group or network of microgrids configured to supply electric power to at least one of the segmental charging infrastructure;
c. non-electrified segments;
d. energy-optimizing operating system (EO-OS) configured to optimize:
(i) operation of the segmental charging infrastructures;
(ii) operation of a group or network of microgrids having an at least one mutual constraint;
(iii) amount of energy transferred from the group or network of microgrids to an at least one storage energy unit;
(iv) energy arbitrage gain over geographic and time without using an electrical grid; and
(v) any combination thereof; and
e. processor configured to
(i) updating time-resolved data of energy supply constrains, rolling stocks energy consumption, location and transport plan thereof; and
(ii) computing, optimizing the energy cost of the system, specifying the timetable, location, and schedules.

In some embodiments, each microgrid of the group or network of microgrids supplies energy to a single segmental charging infrastructure.

In some embodiments, each microgrid of the group or network of microgrids is located along the segmental charging infrastructure it supplies energy to.

In some embodiments, each microgrid within the group or network of microgrids comprises dedicated power sources, non-dedicated power source, power loading, power capacity, and any combination thereof.

In some embodiments, each microgrid within the group or network of microgrids is self-contained.

In some embodiments, charging of the energy storage unit depends on amount of energy consumed, the distance to next segmental charging infrastructure, final destination, microgrid power availability, segmental charging infrastructure capability and energy storage unit charging rate including any combination thereof.

In some embodiments, the energy storage unit comprises electrical energy at any given time.

In some embodiments, charging rate of the energy storage unit depends on
a. amount of electric power available at the microgrid;
b. segmental charging infrastructure capability to transfer energy; and
c. rolling stock storage charging rate capabilities.

In some embodiments, the energy storage unit is configured to supply electric energy to the rolling stock while passing non-electrified segments.

In some embodiments, the EO-OS comprises
a. real-time energy supply constraints; current and predictive locomotive energy consumption; real-time location and transport plan information for each locomotive;
b. a wireless connection configured to send the energy plan to rolling stock, energy management system, microgrid, and any combination thereof;
c. a microgrid optimization energy flow optimization model;
d. a microgrid location optimization model; and
e. at least one database.

In some embodiments, the EO-OS operates through online intercommunication between rolling stocks and the segmental charging infrastructure.

In some embodiments, the processor further comprises a machine learning comprising
a. collecting updating time-resolved data related to energy consumption;
b. preprocessing of the collected data for analyzing, the preprocessing is selected from a group consisting of data cleaning, data transformation, data reeducation, data reduction, data quality assessment, and any combination thereof;
c. training a model for energy consumption, the model is an optimization model selected from a group consisting of linear programing, integer linear programming, mixed-integer linear programing, nonlinear programing, dynamic programing, quadratic programing, mixed quadratic programing, stochastic programming, and metaheuristic optimization algorithms, including any combination thereof;
d. validating thereby tunning hyperparameters, the hyperparameters are selected from a group consisting of speed profile, acceleration and deceleration rates, regenerative braking, train schedule and timetable, power management, train composition, weather conditions, and energy storage system, including any combination thereof; and
e. testing thereby evaluating the model performance.

In some embodiments, the electrification system further configured to transfer energy from one microgrid to another.

In some embodiments, the transferred energy is sold to a grid.

In some embodiments, the electrification system is renewable.

It is hence another object of the invention to disclose a method for producing an optimized microgrid plan configured to supply power to a rolling stock comprising:
a. at least one segmental charging infrastructure;
b. a group or network of microgrids configured to supply electric power to the at least one segmental charging infrastructure, the microgrids comprises at least one mutual constrain, a decision variable, and any combination thereof;
c. energy storage unit of the rolling stock;
d. an energy-optimizing operating system (EO-OS) configured to optimize:
(i) operation of the segmental charging infrastructures;
(ii) operation of a group or network of microgrids having an at least one mutual constraint;
(iii) amount of energy transferred from the group or network of microgrids to an at least one storage energy unit;
(iv) energy arbitrage gain over geographic and time without using an electrical grid; and
(v) any combination thereof.
   wherein at any given moment energy within the energy storage unit is positive.

In some embodiments, the method minimizes levelized cost of energy.

In some embodiments, the optimized microgrid plan recommends:
a. where to position the group or network of microgrids;
b. where to position the segmental charging conductors; and
c. length of the segmental charging conductors.

A method for charging an at least one storage energy unit in a segmental charging infrastructure comprising
a. TRAINi having an energy storage unit;
b. a segmental charging infrastructure configured to charge the energy storge unit while it passes through or in the segmental infrastructure;
c. a group or network of self-maintain microgrids, MGj;
d. an un-electrified segment of the track;
e. an energy-optimizing operating system (EO-OS) configured to optimize:
(i) operation of the segmental charging infrastructures;
(ii) operation of a group or network of microgrids having an at least one mutual constraint;
(iii) amount of energy transferred from the group or network of microgrids to an at least one storage energy unit;
(iv) energy arbitrage gain over geographic and time without using an electrical grid; and
(v) any combination thereof; and
d. a processor;
   wherein the energy storage unit comprises energy at any given time.

In some embodiments, the method is further configured to transfer energy from one microgrid to another.

### BRIEF DESCRIPTION OF THE DRAWINGS

The presently disclosed subject matter may be more clearly understood upon reading in the following detailed description embodiments of non-limiting exemplary embodiments thereof, with reference to the drawings.

Dimensions of components and features shown in the figures are chosen for convenience or clarity of presentation and are not necessarily shown to scale. Wherever possible, the same reference numbers will be used throughout the drawings and the following description to refer to the same and like parts.

FIG. 1 is a scheme illustrating energy flow in a single microgrid, according to some embodiments of the present invention. The single microgrid comprising a solar power source, an energy storage system and a grid connection.

FIG. 2 is an illustration presenting a general diagram of a segmental electrification system according to some embodiments of the invention.

FIG. 3 is an illustration presenting a direct current energy supply for a segmental charging infrastructure according to some embodiments of the present invention.

FIG. 4 is an illustration presenting an alternating current energy supply for a segmental charging infrastructure according to some embodiments of the present invention.

### DETAILED DESCRIPTION OF THE PREFERRED EMBODIMENTS

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be limiting.

Further embodiments and the full scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

According to one aspect of the invention, there is disclosed a method for constructing and efficiently managing a segmental electrification system, comprising, a segmental charging infrastructure configured to charge an energy storge unit while it passes through or in the segmental infrastructure, an off-grid electrification system, un-electrified segments, an energy-optimizing operation system (EO-OS) and a processor.

As used herein, the term “segmental electrification system” refers to a network comprising an at least one segment which is not connected to an on-grid power supply. Typically, in a conventional electrification system all segments are connected to an electric power supply, an on-grid power supply. Whereas, in the present invention an at least one segment is devoid of on-grid connection. It helps reduce the cost and complexity of a full-route electrification, especially in regions where full electrification might not be economically viable or necessary. A conventional electrification system is based on grid power source, whereas the segmental electrification system of the present invention mainly works on an off-grid microgrid. In some embodiments the network is a railway network. As used herein, the term “railway network” refers to the interconnected system of rail lines, tracks, stations, and supporting infrastructure. The railway network enables safe movement of passengers and freight over short and long distances.

As used herein, the term “off-grid” refers to a system or location that operates independently of the main electricity grid. In off-grid systems, generation, storage and consumption of the electricity is on site, an off-grid system does not rely on external power sources or grids.

As used herein, the term “microgrid” refers to a small-scale, localized power system that can operate independently or in conjunction with the main electrical grid. It typically includes energy sources such as solar panels, wind turbines, or diesel generators, energy storage (like batteries), and control systems. Microgrids are designed to provide power to a specific area, such as a neighborhood, campus, or industrial facility, and can operate independently if the main grid goes down, enhancing reliability and resilience. Microgrid is a self-sufficient energy system configured to serve a load at a discrete geographic footprint. As used herein, the term “load” refers to load refers to the amount of electrical power or energy consumed by devices, equipment, or systems connected to the electrical grid or a microgrid.

As used herein, the term “group or network of microgrids” refers to a system comprising multiple microgrids that can operate independently. The group or network of microgrids are devoid of any physical connection, energy cannot directly pass from one microgrid to another. The group or network of microgrids are defines them as a group/network is a constrain. For example, the amount of energy supplied to a train by each microgrid (through its segmental charging infrastructure) along the train route has to be enough for the train to arrive at its destination. A person skilled in the art would appreciate that this constrain binds all of the microgrids since the amount of energy supplied by any specific microgrid influences the train ability to reach its destination. The microgrid operates independently from a main power grid, or connect to it but it functions as a single controllable unit. The amount of energy that can be transferred to the train at a specific segmental charging infrastructure, depends on (i) the charging segment conductor cross section, (ii) the train (iii) the microgrid, (iv) the energy storage system (ESS) characteristics and (v) the state of charge of trains energy storage unit. Each microgrid within the group or network of microgrids is identified by a number, j, also referred herein as MGj.

As used herein, the terms “energy storage unit” and “storage energy unit” are used interchangeably and refer to a battery.

As used herein the terms “energy”, and “electric energy” are used interchangeably.

As used herein, the term “efficiently managing” refers to achieving the best possible outcomes with the resources available, through careful planning, organization, and execution. In some embodiments, efficiently managing is characterized by a reduction in cost of at least 10%, at least 15%, or at least 20%, including any value or range in between, compared to a full electrification system. Each possibility represents a separate embodiment of the present invention.

In some embodiments, efficiently managing is characterized by a reduction in power consumption of at least 10%, at least 15%, or at least 20%, including any value or range in between, compared to a full electrification system. Each possibility represents a separate embodiment of the present invention.

As used herein, the term “train”, and “locomotive” are used interchangeably and refer in a non-limiting manner to one or several rail-connected vehicles and/or road, trail, cable, support or path-constrained vehicle, including e.g., manned or unmanned vehicle, automatic or non-autonomous vehicle, which may include railroad vehicles of the present invention, that are capable of being moved together along a guideway, such as rail tracks, a railway, a rail line, a commuter line, to transport freight and/or passengers and a freight line (any one of which may be a train that rolls, or a train that is magnetically levitated). While a train generally includes one or more locomotives to provide power for locomotion along rail tracks, trains comprising embodiments of the present invention may power along a microgrid of rail tracks without a locomotive. The terms may be used here to mean a vehicle that moves along a rail, a vehicle that moves along a guideway as in a maglev train system, or a wheeled vehicle that must follow a catenary in order to receive electric power from the catenary for powering the vehicle.

The term “train” also means single vehicle, or any plurality of such vehicles connected in tandem. Those terms also refer to a trolley car or any other kind of rail vehicle that is unconnected to other vehicles in tandem but moves along a rail or guideway, or a car in a train of cars pulled by an engine, or a vehicle of a maglev train, or a wheeled bus that must be steered so as to follow a catenary system from which it receives electric power. Such a vehicle can be connected in a train or not be connected to any other such vehicles, and can move under the force of a separate train engine vehicle pulling or pushing the vehicle, or it can move using electric power provided by an external source via a catenary system or a via a third rail (possibly in combination with a fourth rail) or it can move under forces provided by a guideway (which forces are usually magnetic, and typically springing from electromagnetic systems). The train is a part of a railroad system (also used herein as a railway network).

In some embodiments, the rail system comprises at least one of the following elements: spur tracks, tracks, platforms, stations, signaling systems, switches and crossings, yards, bridges and tunnels, catenary system, or control centers, including any combination thereof. In some embodiments, the catenary system provides electrical power to the train. In some embodiments, the spur tracks refer to a rail road track that is branched off form a main.

In some embodiments, a freight train is created by combining a locomotive and a freight car. In some embodiments, a freight train is created at a departing yard.

In some embodiments, the segmental electrification system comprises a rolling stock. As used herein, the term “rolling stock” refers to all vehicles that move on a railway track, including both powered and unpowered units.

According to another aspect of the invention, there is disclosed a method for constructing and efficiently managing a segmental electrification system, comprising a rolling stock having an energy storage unit, a segmental charging infrastructure configured to charge the energy storge unit while it passes through or in the segmental infrastructure, electrified segments of the track, un-electrified segments of the track, an EO-OS and a processor.

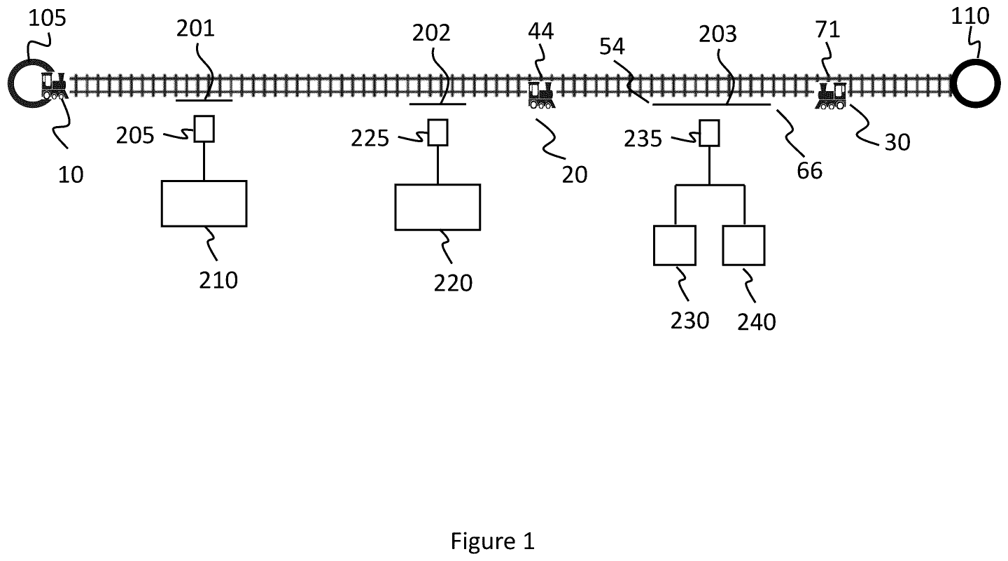

Reference is now made to FIG. 1, presenting a general illustration 100 of a segmental electrification system according to some embodiments of the invention. Diagram 100 presents a specific moment in time where train 10 departers from yard S, 105, and heads towards yard e 110, its final destination. Train 20 is located at milestone 44, heading towards yard E, 110, and train 30 is located at milestone 71 heading towards yard S, 105. Diagram 100 comprises three segmental charging infrastructures, 201, 202 and 203, also referred to herein as segmental charging conductor. Each segmental charging infrastructures, 201, 202, and 203, is connected to a microgrid 210, 220, 230 and 240. Each microgrid (200, 220, 230 and 240) is configured to transfer electrical energy from microgrid to a train passing through it. Microgrid 205 transfers energy to segmental charging infrastructure 201. Microgrid 225 transfers energy to segmental charging infrastructure 202. Microgrid 235 transfers energy to segmental charging infrastructure 203. The amount of energy transferred from the segmental charging conductor to the train depends on the state of charge of the train energy storage unit, the microgrid ESS, the charging segment conductor characteristics, the time the train spends in or the segmental charging infrastructure, including any combination thereof.

As used herein, the terms “segmental electrification system” and “electrification system” are used interchangeably.

Each microgrid receives electric power from a power supply, the power supply can be on-grid power supply, off-grid power supply, or any combination thereof. A microgrid can receive electric energy solely form one off-grid power supply. Power supply 210 supplies energy to microgrid 205, power supply 220 supplies energy to microgrid 225, and power supplies 230 and 240 supply energy to microgrid 235. In some embodiments, the microgrid receives energy from at least one on-grid power supply, or off-grid power supply, including any combination thereof.

Each microgrid can be located at any milestone along the segmental charging infrastructure it supplies energy to. For example, a microgrid supplying power to segmental infrastructure 235 located between milestone 54 and 66, can be placed anywhere along milestones 54 to 66.

In some embodiments, a microgrid supplying energy to a segmental charging infrastructure comprises off-grid power source, on-grid power source, or any combination thereof. Non-limiting examples of off-grid power source include but are not limited, biomass generator, mini-hydro system, wind-power system, or solar system, including any combination thereof.

In some embodiments, the segmental charging infrastructure solely belongs to one microgrid. In some embodiments, the segmental charging infrastructure carries electrical current from only one microgrid. In some embodiments, the segmental charging infrastructure comprises or is a segmental charging conductor. In some embodiments, the segmental charging conductor ensures an efficient transmission and distribution from the group or network of microgrids to the energy storge unit.

In some embodiments, the segmental charging infrastructure is configured to charge an energy storage unit. In some embodiment, the segmental charging infrastructure is configured to charge an energy storage unit of a rolling stock. In some embodiments, the energy storage unit is within or attached to a rolling stock. In some embodiment, is configured to charge an energy storage unit of a locomotive.

In some embodiments, the segmental charging infrastructure charges the energy storage unit with sufficient amount of electrical energy. As used herein the term “sufficient amount of electrical energy” refers to the amount of energy required for the rolling stock to run/drive on un-electrified segments until it arrives to another segmental charging infrastructure, or destination, including any combination thereof.

In some embodiments, the segmental charging infrastructure are powered by a group or network of microgrids. In some embodiments, the microgrids are self-contained power systems. As used herein, the term “self-contained power system” refers to microgrids that generate, distribute, manage electricity and function independently of the main power source. In some embodiments, each microgrid of the group or network of microgrids, supplies energy to one segmental charging infrastructure.

In some embodiments, the energy storage unit is charged in the segmental charging infrastructure or while passing through the segmental charging infrastructure, including any combination thereof. As used herein, the terms “segmental charging infrastructure”, “segmental charging conductor”, and “conductor” are used interchangeably.

In some embodiments, the segmental charging infrastructure is in a form of a third rail, overhead infrastructure, or any combination thereof. As used herein, the term “overhead infrastructure” refers to infrastructures (conductors) strung above the ground, typically by poles or towers to prevent interference with human activities and to ensure safety. Overhead infrastructure are commonly used for transmitting electricity over long distances. As used herein, the term “third rail” refers to an additional rail installed alongside or between the main tracks. It carries electrical power, typically for powering electric trains. The trains draw power from the third rail via a contact shoe, which slides along the rail. Unlike overhead wires, the third rail is installed at ground level, and it is insulated to protect against accidental contact.

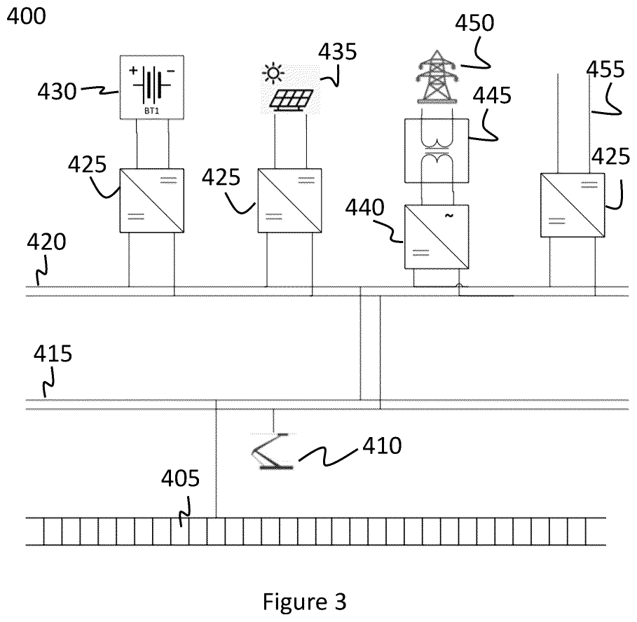

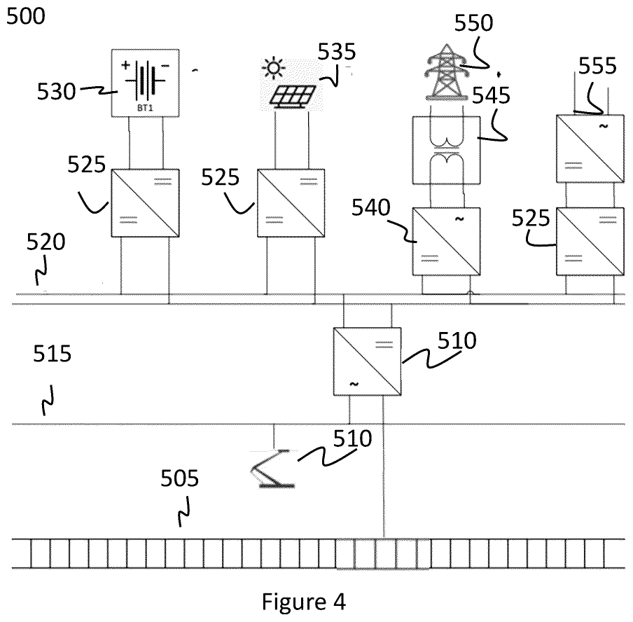

Reference is now made to FIG. 3 and FIG. 4 presenting direct current and alternating current energy supply for a segmental charging infrastructure, respectively, according to some embodiments of the present invention.

FIG. 3 illustrates a segmental charging infrastructure working on direct current. The segmental charging infrastructure can charge in a form of an overhead infrastructure 410, or in a form of a third rail 405. Both 410 and 405 are supplied direct current which transfers from a power supply to a microgrid bus bar 420 to a segmental charging conductor 415. Power can be supplied by a battery 430, a solar farm 435, a grid 450, or any other direct current known power supplies 455. Battery 430, solar farm 435, and other direct current (DC) power supplies 450, are connected to a DC-DC convertor 425. The energy supplied from a grid is an alternating current (AC) therefore the energy supplied from the grid is connected to a transformer 445 and a rectifier 440 to convert the voltage obtained by the grid to a DC current. In some embodiments, the segmental charging infrastructure further comprises other alternating current known power supplies. In some embodiments, the other alternating current known power supplies is passed through a rectifier and then a DC-DC convertor.

As used herein, the term “busbar” is a conductor in a shape of a bar or strip. The busbar an electric conductor configured to distribute electric power within an electric system. The busbar is characterized by low resistance, and excellent electrical conductivity.

As used herein, the term “DC-DC convertor” refers to a device configured to convert direct current (DC) electrical power from one voltage level to another. It enables either increase or decrease the voltage of the power supplied. In the present invention the DC-DC converters located within the microgrid are responsible for synchronizing the voltage of all elements connected to the microgrid busbar.

A “transformer” refers to a device that transforms electrical energy between two circuits through electromagnetic induction. Transformers are commonly used to change the voltage level of alternating current (AC) electrical power. A “rectifier” refers to a device that converts AC into direct current DC.

FIG. 4 illustrates a segmental charging infrastructure working on alternating current. The segmental charging infrastructure can charge in a form of an overhead infrastructure 510, or in a form of a third rail 505. Both 510 and 505 are supplied with DC. The DC is transferred from a power supply to a microgrid bus bar 520 to a segmental charging conductor 515. Power can be supplied by a battery 530, a solar farm 535, a grid 550, or any other known power sources 555. Battery 530, solar farm 535, are connected to a DC-DC convertor 525. The energy supplied from grid 550 is connected to a transformer 545 and a rectifier 540 to convert the voltage obtained by the grid to a DC current. If the other known power sources 555 is an AC power supplier it is connected to a transformer 545 and then to a DC-DC convertor. If the other known power supplies 555 is a DC power source it is connected to a DC-DC convertor. All of the current obtained from all power supplies is connected to a mutual dc busbar, an invertor configured to convert the busbar de current to alternating current.

The rolling stock of the present invention comprises an energy storage unit attached to or a part of the rolling stock. In some embodiments, the energy storage unit is a battery. In some embodiments, the energy storage unit is configured to store electric energy and supply power to the rolling stock. In some embodiments, the energy storage unit supplies power to the rolling stock while it runs on un-electrified segments of the network. In some embodiments, the energy storage unit supplies power to the rolling stock while it transfers from one segmental charging infrastructure to another until it arrives at its destination.

In some embodiments, each train in a railway network is at least characterized by an identification number, an integer, i (also refer herein as TRAINi), departing time, final destination, number of locomotives, storage capacity, priority, gross ton and rail operator scheduled, indulging any combination thereof. As used herein, the term “departing time” is referred to as the time TRAINi left its origin yard. Upon arrival at its final destination TRAINi is reclassified, to create a new train. As used herein, the term “priority” refers to a hierarchical system used by railways to determine the order in which different trains are allowed to use particular sections of a track. Typically, priority is given based on the type of train, its purpose, and its importance in the overall network.

Non-limiting examples for real time train measurements include but are not limited to GPS tracking, track side sensors, speed sensors, speed limits compliance, engine performance, brake system monitoring, or any combination thereof.

In some embodiments, an amount of energy transferred to an energy storage unit of TRAINi is represented by ENERGYij, wherein i represent the rolling stock number, TRAINi, comprising the energy storage unit and j represents the microgrid from which the segmental charging infrastructure receives its electric energy. J is an integer, is an identification number of the microgrid.

In some embodiments, the amount of ENERGYij varies from zero to a positive max constrain. In some embodiments, ENERGYij is between zero and the max constrain when the energy is transferred from the segmental charging infrastructure to the energy storage unit of a train. In some embodiments, ENERGYij (lower than zero) is when energy is transferred from the energy storage unit to the segmental charging infrastructures. In some embodiments, ENERGYij equals time it takes TRAINi to pass through segmental charging infrastructure multiplied by charging rate. For example, a TRAIN pass through a segmental charging infrastructure having a charging rate of 30 MW, in half an hour, therefore, the amount of energy transferred from the segmental charging infrastructure to the energy storage unit of a train is 15 MWH.

In some embodiments, ENERGYij depends on (i) amount of electric power available at microgrid j, upon Traini and segmental charging infrastructure encounter; (ii) capability of the segmental charging infrastructure to transfer electric power; or (iii), charging rate capabilities of the energy storage unit of TRAINi, including any combination thereof.

As used herein, the term “charging rate ij” (also referred to herein as CHARGINGij) refers to the rate that an electric power is transferred from microgrid j to TRAINi and vice versa. A person skilled in the art would appreciate that charging rate varies from train to train and from segment to segment.

In some embodiments, the capability of the segmental charging infrastructure to transfer electric power depends on the segmental charging conductor resistance, segmental charging conductor cross section, or ambient temperature including any combination thereof. MGj can be located at any milestone along the segmental charging infrastructure. A person skilled in the art would appreciate that the placement of MGj along segmental charging infrastructure depends on various parameters, including geographical factors such as terrain, proximity to renewable energy sources (e.g., solar or wind), local energy demand, and accessibility to existing infrastructure. These considerations ensure that the MGj can efficiently supply power to the segmental charging infrastructure while optimizing performance and cost-effectiveness.

In some embodiments, a longer segmental infrastructure allows for a greater energy transfer.

In some embodiments, TRAINi is characterized by speed (referred to herein as TRAINi speed). As used herein the term “TRAINi speed” represents the TRAINi average speed while it passes through segmental charging infrastructure.

In some embodiments, TRAINi is characterized by an energy consumption (referred to herein as TRAINi j,j+1) from one point to another. As used herein the term TRAINi j,j+1 refers to the energy consumption of TRAINi from microgrid j starting point to microgrid j+1 starting point.

In some embodiments, TRAINi j,j+1 depends on TRAINi gross weight, track nature, or speed, including any combination thereof. As used herein, the term “track nature” refers to whether the track has a slope (inclined/declined) or not.

In some embodiments, the TRAINi j,j+1 is obtained by real time trains measurements, and adjusted based on the TRAINi weight and priority for other trains. In some embodiments, the

In some embodiments, TRAINi comprises electrical energy within its energy storage unit.

In some embodiments, each microgrid within the group or network of microgrids is identified by a number, j, also referred herein as MGj. In some embodiments, MGj comprises an at least one power source. In some embodiments, the MGj power source comprises a dedicated power source, or a non-dedicated power source, including any combination thereof.

In some embodiment, a dedicated power source supplies its electric energy solely to MGj. As used herein, the term “dedicated power source” means that the energy generated by the power source, is solely supplied to MGj. In other words, since the MGj is required to buy all the power no matter what. The electric power has been pre-purchased by the MGj so there is no need to set a price based on how much is needed or how much is available.

Non limiting examples of dedicated power source include but are not limited to solar power, or wing turbine system, including any combination thereof. In some embodiment, the dedicated power source comprises an off-grid power supply.

In some embodiments, the dedicated power source is or comprises a solar power system. A person skilled in the art would appreciate that the energy capacity of a solar power system is directly influenced by the amount of sunlight the solar farm is exposed to, which is affected by factors such as geographical location, seasonal variations, and local weather patterns. Maximizing solar exposure is crucial for optimizing the system's overall energy output and efficiency.

In some embodiments, a non-dedicated power source, is supplied to more than one system. In some embodiments, power supplied by a non-dedicated power source is not reserved for a specific purpose. In some embodiments, power supplied by a non-dedicated power source is not reserved for a specific MGj. In some embodiments, the cost of a non-dedicated power source varies and depends on time of day.

In some embodiments, MGj is connected to an off-grid power supply, an on-grid power supply, or any combination thereof.

In some embodiments, MGj are located in a manner that the levelized cost of energy of the electrification system of the invention is minimum. In some embodiments, MGj length depends on MGj location on the railway, the energy source cost, location of sequential MGj, energy cost, including any combination thereof.

In some embodiment the amount of energy transferred from MGj to the segmental charging infrastructure, from the segmental charging infrastructure to TRAINi, and vice versa is controlled by contactors and an energy management system (EMS). In some embodiments, the EMS controls how electrical energy flows from the MGj, TRAINi and segmental charging infrastructure.

In some embodiments, the amount of energy transferred from the microgrid to the train and vice versa, is controlled by the EO-OS. In some embodiments, the EO-OS is configured to instruct the rolling stock recommendation selected from the group consisting of when and where to charge its energy storage unit.

In some embodiments, the EO-OS is configured to optimize the MGj power flow within the MGj, or ENERGYij, including any combination thereof. In some embodiments, EO-OS optimizes the energy cost during a specific period of time by predefining a future plan for the MGj power flow. In some embodiments, the EO-OS is configured to store electric energy in the MGj when grid energy cost is low. In some embodiments, the EO-OS is configured to sell energy by discharging energy stored in the MGj at peak hours to the grid, when the price is high. In some embodiments, the power flow within MGj is controlled by the EO-OS by using DC-DC converters and contactors.

In some embodiments, the power flow from the microgrid MGj to the TRAINi or from the TRAINi to the MGj is controllable. In some embodiments, the power flow is represented by ENERGYij and refers to the amount of energy transferred from microgrid MGj to TRAINi, or from TRAINi to MGj.

In some embodiments, a part of the energy transferred from the MGj to the TRAINi goes directly to the traction motor load and rest goes to the energy storage unit of a locomotive.

In some embodiments, the optimization of MGj power flow is by an optimization model selected from a group consisting of linear model, integer linear model, mixed-integer linear model, nonlinear programing, dynamic model, quadratic model, mixed quadratic model, stochastic model, and metaheuristic optimization algorithms, including any combination thereof. In some embodiments, the optimization model is a linear programing model. The optimization model of MGj energy flow output represents the energy flow within each MGj in the system at a given time.

In some embodiments, there are interdependencies between at least two microgrid. In some embodiments, there are mutual constrains between at least two microgrids. In some embodiments, there is at least one mutual constrain between at least two microgrids. In some embodiments, at least one mutual constrain is or comprises that TRAINi has enough energy to reach its destination.

In some embodiments TRAINi is a sustainable transportation. In some embodiments TRAINi comprises ability to run on renewable energy, or generate its own energy from fuel, including any combination thereof. In some embodiments, electrification system of the invention dictates the amount of energy generated by TRAINi and amount of renewable energy used during TRAINi journey.

In some embodiments, the EO-OS is configured to control power flow from: (i) TRAINi 340 to MGj 300, (ii) MGj solar 320 to TRAINi 340, (iii) MGj solar 320 to grid 330, (iv) grid 330 to MGj ESS 310, (v) grid 330 to TRIANi 340, or (vi) MGj ESS 310 to TRIANi 340. MGi solar 320 to MGi Ess 310.

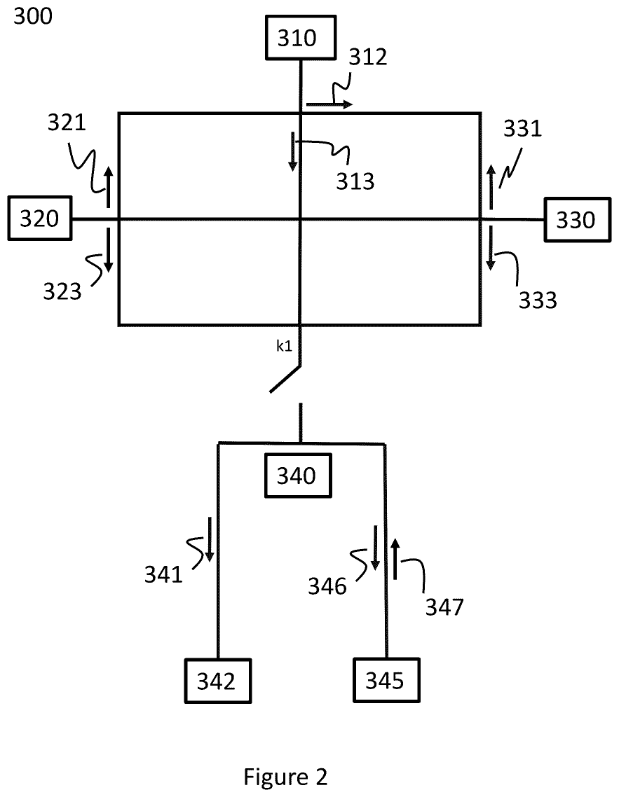

Reference is now made to FIG. 2, describing a single MGj 300 consisting of an energy storage system (ESS), 310, a renewable power source (320) and a grid (330). The power source can be a dedicated power source, a nondedicated grid connection, or both. The ESS is configured to store energy supplied (321) by power source 320, or energy supplied (331) by grid 330, including any combination thereof. In some embodiments, 320 is a solar farm. Grid 330 is configured to receive energy (322) supplied by power source 320, or energy (312) supplied by ESS 310, including any combination thereof. Grid 330 is configured to supply energy (331) to ESS 310, or supply energy (333) to TRAINi 340, including any combination thereof. As used herein, the term load refers a device, system or any component that consume the electrical power transferred from the power source. The arrows in FIG. 2 demonstrate the power flow direction. TRAINi 340 is configured to receive energy (323) supplied by power source 320, energy (323) supplied by ESS, or energy (333) supplied by grid 330, including any combination thereof. TRAINi is the TRAINi passing through MGj 300 at time t. As long as the segmental infrastructure is empty (is devoid of TRIANi 340), energy flows solely within MGj. When TRAINi 340, that needs to be charged passes throw the segmental charging infrastructure, energy stats flowing form MGj 300 to TRAINi 340. This is theoretically explained by k1, that mimics the opening and closing of a circuit.

The energy the TRAINi receives (i) flows (341) to the train load, and (ii) flows (346) to the energy storage unit 345. Energy can flow from the energy storing 347 unit of TRAINi to the load.

In some embodiments, energy transfers from and to but not simultaneously. For example, energy transfers either from grid 330 to ESS 310 or from ESS 310 to grid 330. In some embodiments, each power flow direction has its own limitation. In some embodiments, power flow direction constrains dictate how and where energy flows within a network. In some embodiments, power flow direction constrains are crucial for maintaining system stability, efficiency, and safety. Non-limiting examples of power flow direction constrains include but are not limited to storage state of charge, grid connection limit, or storage charging and discharging rate, including any combination thereof.

In some embodiments, the EO-OS is configured to control at which MGj TRAINi will be charged in while passing, and amount of ENERGYij transferred. For example, if we compare two train traveling in the same route, but they differ in the trains weight, the lighter train, the one having a lower gross weight, will require less energy to run throw the same route. The EO-OS can decide to supply less energy or by charging less energy at each segmental charging infrastructure or charging at different segmental charging infrastructures (devoid charging at all segmental charging infrastructures along the route).

There is a strong relationship between an energy plan the EO-OS will produce and the total energy cost of the electrification system. For example, TRAINi is supposed to pass along it route throw MGj and MGj+1 both having solely dedicated power source, and MG1 and MG2 state of charge is 50% and 95%, respectfully. Charging TRIANi solely at MG1, will lead to energy lost compared to charging TRAINi at MG2 having a state charge of 95%. As used herein, the term state of charge refers to the level of charge in a battery relative to its full capacity. For example, state of charge of 100% represents a fully charged battery, where as a state of charge of 0% indicates a battery is completely discharged.

In some embodiments, transferring ENERGYij from TRAINi to MGj enabling energy transfer from one MGj to another. In some embodiments, transferring ENERGYij from TRAINi to MGj lower the total energy cost of the electrification system. For example, MGj is connected to a grid and can sell electricity to the grid at peak hours. If a charged TRAINi comprises enough electrical energy, it can transfer electrical energy while it passes through MGj to MGj, which can store it and sell it at peak hours.

In some embodiments, total energy cost of at least one group or network of microgrids comprises subtracting the revenue from energy sold by MGj from the total non-dedicated power cost.

In some embodiments, the EO-OS is configured to ensure that TRAINi arrives at its destination. Non-limiting examples of things that can affect the TRAINi arrival include but are not limited to malfunctions, energy supply constraints, or changes in schedule, including any combination thereof.

In some embodiments, the EO-OS is configured to find the optimize option that enable TRAINi to arrive at its destination. non limiting examples of optimize option include but are not limited to lowest energy cost, greater resilience, and any combination thereof.

In some embodiments the EO-OS comprises
a. Real-time energy supply constraints; Current and predictive locomotive energy consumption; Real-time location and transport plan information for each locomotive;
b. a wireless connection configured to send the energy plan to TRAINi EMS, MGj, or both;
c. a microgrid optimization energy flow optimization model;
d. a microgrid location optimization model and
e. at least one database.

As used herein, the terms “microgrid optimization energy flow optimization model” and “energy flow optimization model” are used interchangeably. As used herein, the term “online intercommunicating” refers to real-time exchange of information between different entities through digital or online communication channels. Non-limiting examples of online intercommunicating in a railway network include but are not limited to communication between train operators, signaling systems, control centers, maintenance teams, or charging and swapping stations, including any combination thereof. Online intercommunicating can be line-communication or, wireless communication, as used herein, the term “wireless communication” refers to transmission of information between devices that are not physically connected. Wireless communication typically relies on electromagnetic signals. Non-limiting examples of electromagnetic signals include but are not limited to radio waves, microwaves, or infra radiation, including any combination thereof.

Non-limiting examples of real time data include but are not limited to energy constrains, train location, energy supply, additional departing trains, malfunctions. In some embodiments, the energy flow optimization model runs every time a change is observed in the real time data compared to the original train plan. In some embodiments, the energy flow optimization model runs at a predetermined period of time, for example every five minutes. In some embodiments the energy flow optimization model runs every time there is a significant change in the database like train schedule, malfunction in MGj, or any combination thereof.

In some embodiments, the at least one database comprises system parameters data, monitoring database, historic database, or forecast database, including any combination thereof.

In some embodiments, the system parameters database comprises fixed system parameters. Non limiting examples of system parameters include but are not limited to energy storage capacity in MGj, storage capacity of the energy storage unit of TRAINi, amount of energy at a given time within MGj, amount of energy at a given time within the energy storage unit, power source capacity, energy loss matrix, charging rate constrains, MGj location, or power price, including any combination thereof.

In some embodiments, the monitoring database is or comprises data that continuously changes. In some embodiments, the monitored data creates a better forecast database. Non limiting examples of monitoring data include but are not limited to amount of dedicated power source, state of charging of the energy storage in MGj, state of charging of the energy storage unit of TRAINi, TRAINi location, TRAINi energy consumption, rail operator schedule, or whether forecast, including any combination thereof.

In some embodiments, the monitoring data is stored, building the historic database.

In some embodiments, the forecast database comprise parameters predicted by an AI-powered forecast. In some embodiments, the AI-powered forecast is configured to predict constrains required for the energy flow optimization model period. In some embodiments, the AI-powered forecast uses monitoring data, system parameters and historical parameters to predict the constrains or decision variables, including any combination thereof. In some embodiments, the AI-powered forecast is configured to predict arrival time of each TRAINi to each MGj within its route, TRAINi energy consumption from its departure point to its arrival point, amount of power supplied to TRAINi by dedicated power source or, including any combination thereof. In some embodiments, the predict parameters are used in the energy flow optimization model. In some embodiments, the forecast database and the system parameter database are used to create the energy flow optimization model constrains and/or decision variable.

In some embodiments, the energy flow optimization model is or comprises a mixed integer model problem. A Mixed Integer Programming (MIP) problem is an optimization problem that involves both continuous and integer decision variables. MIP models are commonly used when some decisions are naturally discrete (e.g., yes/no decisions, number of items) while others can vary continuously (e.g., amounts of resources). To formulate a MIP problem, you follow the general steps of any mathematical optimization model but account for the fact that some of your variables will be constrained to take integer values. In general, steps for formulation: 1. define the decision variables; 2. define the objective function; 3. specify the constrains; or any combination thereof. An example of how to use the described model is presented in Example 1.

In some embodiments, the energy flow optimization model is configured to produce an energy plan for predetermined period of time for each MGj in the system. As used herein, the term “energy plan” refers to the energy flow in each MGj at any given second in the predetermined period of time that guaranties TRAINi has enough energy to arrive at its destination. As a function of the energy plan the amount of energy transferred, ENERGYij, at each TRAINi segmental charging infrastructure is defined. Since the information to form the constrains or decision variables, including any combination thereof continuously changes, the energy flow optimization model will run every time a crucial change in the information has occurred for example, a trin is unexpectedly delayed for several hours, a malfunction in the grid, or every predetermined time, for example every 5 minutes.

In some embodiments, the electrification system of the present invention further comprises a microgrid location optimization model configured to produce an optimized microgrid plan. In some embodiments, the microgrid location optimization model comprises three parameters, an objective function, decision variables, and constrains, and its output is an optimized microgrid plan. The optimized microgrid plan is configured to ensure that TRAINi will arrive at their destination, or the segmental electrification system would be and account for both the infrastructure setup expenses and the long-term energy costs over a period of time, including any combination thereof.

As used herein, the term “optimized microgrid plan” refers to where should a segmental charging infrastructure be placed and what should its length be. The optimized microgrid plan comprises at least one MGj defined by a milestone position (also referred herein as MILESTONx) and a milestone length, MGj energy storage position.

In some embodiments, the microgrid location optimization model comprises at least one constrain, or decision variables, including any combination thereof. Non-limiting examples of constrains for the microgrid location optimization model includes but are not limited to each TRAINi has to reach its destination charging infrastructure energy costs, or capital expenditure, including any combination thereof.

In some embodiments, the MGj milestone length refers to the segment charging infrastructure length. In some embodiments, the MGj position should be in the middle of the MGj milestone length. As used herein the term, milestone length and segmental charging infrastructure are used interchangeably.

As used herein, the term “milestone energy cost”, refer to the cost of energy to be supplied or generated in a specific milestone and is measured as dollar per MWH The milestone energy cost represents the levelized cost of energy (LOCE) of a MG while it is located at a specific point. In some embodiments, the milestone energy cost depends on land cost and amount of sun light. For example, the milestone energy cost in Arizona would be cheaper than in Canada, because in Arizona there is high exposure to sunlight and low cost of land compared to Canada.

In some embodiments, the milestone is located where only on-grid power supply is available. In some embodiments, the milestone energy cost of MGj connected to on-grid power supply is determined by a power purchase agreement.

As used herein, the term “milestone infrastructure cost” refers to a cost of a segmental charging infrastructure compared to 1 MHW of energy supplied to the TRAINS at the segmental charging infrastructure milestone.

In some embodiments, the milestone infrastructure cost is presented by Equation 1:

$$Milestone infrastructure cost = \frac{fix cost of 1 mile of the segmental charging infrastructure}{\frac{charging rate}{train speed} \times daily number of train}$$

In some embodiments the milestone infrastructure cost is affected by the train speed. A person skilled in that would appreciate that the faster the train goes the less electric energy is passed from the segmental charging infrastructure to the energy storage unit of TRAINi. In some embodiments, the train speed is affected by at least one constrain. Non-limiting examples for train speed constrain include but are not limited minimum/maximum speed, acceleration/deceleration, reducing speed for safety reason, train volume, or stopping at a station, including any combination thereof. In some embodiments, the greater the trains volume the milestone infrastructure cost I lower. As used herein, the term “train volume” refers to the number of trains passing in a specific route.

In some embodiments, the LOCE for suppling 1 MWh of electrical energy to TRAINi at a specific milestone is represented by Equation 2:

$$LOCE for suppling 1 MWh of electrical energy to TRAINi = Milestone energy cost + Moilestone infrastructure cost$$

An example of the optimized microgrid model is seen in Example 3.

According to another aspect of the invention, there is disclosed a method for constructing and efficiently managing a segmental electrification system, comprising TRAINi having an energy storage unit, a segmental charging infrastructure configured to charge the energy storge unit while it passes through or in the segmental infrastructure, a group of self-maintain microgrids, MGj, un-electrified segments of the track, an EO-OS and a processor. In some embodiments, the MGj is configured to transfer electric energy to the segmental charging infrastructure, and vice versa. In some embodiments, the segmental charging infrastructure is configured to transfer electric energy from the segmental charging infrastructure to the energy storage unit of TRAINi.

### EXAMPLES

### Example 1—Energy Flow Optimization Model

To better understand the electrification optimization model according to some embodiments of the present invention, an example of how a single microgrid is optimize is presented using the linear-programing optimization model.

Objective function: minimize the cost of energy over the model period.

Define decision variable, these variables represent controllable features or decidable features, for example controlling the power flow with in MGj, by using contactors and DC-DC converters.

Define constrains, the constrains represent limitation and/or rules that govern the problem, for example energy storage is constrained between a minimum value and a maximum value dictated by the energy storage technology used, or ESS discharging/charging rate. As used herein, the term “constrain” refers to a rule or limitation that govern the problem.

The results of the optimization model are a plan describing the power flow at a specific microgrid at every second during the period tested in the model, for example 24 hours.

In some cases, there are interdependencies or mutual constrains between at least two microgrid, and a decision made for one microgrid can influence the objective function or any other contain of the overall optimization problem.

At least one of the mutual constrains in the present invention is that the train has to have enough energy to reach its destination. This constrain involve, making a destination regarding the amount of ENRGYij transferred at each MGj the TRAINi encounters/passes throw one her travel.

For a particular train, there could be several alternative energy plans depending on the amount of energy it requires to reach its destination. Each energy plan might result in a different value for the objective function.

### Example 2—How to Calculate Minimum Energy Cost

An exemplary calculation of minimum cost of energy of a microgrid comprising a solar farm, an energy storage, and a grid connection is represented by formula 1

### Formula 1:

$$Min cost of energy = Min {\sum }_{t = 1}^{T} \begin{matrix}\begin{matrix}Cost of electricity purchased & revenue of electricity sales\end{matrix} \\ \begin{matrix}( power\_g - L ( t ) + power\_g - ess ( t ) ) * elec \text{?} \_price ( t ) - \\ ( power\_ess - g ( t ) + power pv - g ) * elec \text{?} \_price ( t )\end{matrix}\end{matrix}$$

$$\text{?} \text{indicates text missing or illegible when filed}$$

MGj Power_g-l (t) represent energy flow from grid (320) to a load (340) at specific period of time, t. MGj Power g-ess (t) represent energy flow from grid (320) to energy storage system (310) at specific period of time, t. MGj Power_ess-g (t) represent energy flow from energy storage system (310) to grid (320) at specific period of time, t. MGj Power pv-g (t) represent energy flow from photovoltaic (solar farm, 330) to grid (320) at specific period of time, t.

The minimum energy cost is determined by subtracting the revenue from electricity sales from the calculated cost of purchasing electricity, then summing the result.

The cost of electricity purchased is calculated by summing the electrical power received from the grid and the power obtained from the ESS and multiplying the value by the electric energy price at time t.

The revenue of electricity sales is summing by the amount of energy transferred from the ESS to the grid with the energy supplied by the solar farm, then multiplying the result by the electricity price at time t.

In some embodiments, non-limiting examples for software to solve linear programing model or mixed integer models include but are not limited to Coin- or, GLPK or GOURBI, including any combination thereof

The software performs optimization based on the user definitions. The user has to define the objective function, the variables, constrains and supply a database.

### Example 3—Optimization and Control an Electrification System Based on a Microgrid Network

One of the main goal of the inventors is to ensure TRIANi arrives at its destination even if a malfunction occurs, they have energy constrains or changes in the train time schedule. An additional goal is to obtain the optimized option that ensures TRAINi arrives at its destination.

A model was developed to define the optimized strategy of an energy plan for each MGk based on data obtained at time t.

Objective function: minimize electrification system cost of energy at a defined period, for example 24h.

Cost of energy refers to the cost of power purchased at all MGj during the period of time and minus the revenue obtained from selling energy al all MGj during the period of time. Decision variable: Energy flow at each MGj at a specific time, like seconds and/or minutes.

Constrains: every train must have electrical energy within the energy storage unit at every given time of the journey. This enables the train to arrive at its final destination. In some embodiments, the amount of energy stored within the energy storage unit of the train must enable the train to reach the next staring point of the segmental charging infrastructure. In addition, all of the constrains mentioned in example 1 are relevant here as well.

Result: an energy plan describing the power flow at each segmental charging unit at a specific period of time. The final energy plan is sent wireless to MGj and TRAINi energy management system (EMS), for implantation.

An example on how to define the problem is given using the system presented in FIG. 1.

### Example 3—An Optimized Microgrid Model

The most important constrain when making a microgrid plan is that TRAINi has to be able to reach its destination. The main challenge in building a segmental electrification system is to know where to position the microgrids, the segmental charging infrastructures (segmental charging conductor), and what would the segmental charging conductor length be. The microgrid plan should also minimize the levelized cost of energy of the system, by taking in account energy cost and capital expenditure.

The outcome of the inventors' model is an optimized microgrid plan comprising at least two microgrids defined by a milestone position, a defined location and length for the segmental charging conductor and the position of the microgrid energy storage system.

### Definitions

Milestone energy cost, representing the levelized cost of energy (LOCE) for each milestone. The cost difference in energy between different locations is significant. For example, constructing a solar farm in a nature reserve in Canada, where building new renewable sources is prohibited, necessitates supplying energy from a solar farm located 10 kilometers away with underground infrastructure. This alternative incurs substantially higher energy costs for the end consumer.

Milestone infrastructure cost, representing an average cost to transfer 1 MWH in 1 mile of segmental charging infrastructure/segmental charging conductor.

Milestone X is a milestone were it is possible to construct a solar farm adjacent to the milestone. The \ production of the solar farm is characterized by a 60$/MWH energy cost. A train with a speed of 55 MPH, is near milestone Y, which is characterized by a speed limit of 40 MPH. In milestone Y energy must be supplied by a grid which is energy expected to cost 70$/MWH.

Assuming 30 trains per day pass on the route, and the energy cost of conductor is $1.5 million per mile, having a charging rate of 15 MW. The milestone X infrastructure cost is $33/MWh and for milestone Y is $24/MHW. Although the energy cost of milestone Y is higher than milestone X, milestone Y has a lower LOCE.

Representative train represents a train having a maximum weight relevant for the route.

Milestone daily number of trains represents the number of trains passing through a specific milestone during the day.

Milestone energy consumption represents the energy consumption of the representative train at a specific milestone. If the energy consumption data is missing, it can be asset using the milestone grade speed and weight.

Milestone speed represents TRAINi speed at a specific milestone.

The microgrid in the model is defined using at least two parameters. The microgrid in the model is defined using two parameters its location defined by milestone and the length of the segmental charging conductor in miles. The MGj milestone represents the midpoint of the segmental charging conductor. For example, if MGj is located at milestone 206 and has a 6 mile length this indicates that the micro conductor is between milestone 203 and 209.

In some embodiments, the optimized microgrid model is defined as a mixed integer model.

$$Objective function : minimize the sum of MGj ( ( energy cost + infrastructure cost ) * ( MGj length ) * ( daily number of locomotives ) ) or minimize the sum of MGj ( ( energy cost + infrastructure cost ) * ( MGj length ) * ( daily gross ton volume ) )$$

Decision var: Set of MGj. MGj is defined as (milestone, length).

### Constrains:

a. Representative Train Constraints:
the core constraint of this problem is that the representative train will have positive energy in its storage at all journey time.

The energy transfer to the locomotive at each microgrid is equal to (charging rate/speed)*MG length

b. Microgrid Constraints

The length of the segmental charging conductor has a minimum length, do to economy scale up reasons and a maximin length as a result of energy loss (min<microgrid length<max).

There are no overlaps microgrids

c. Storage Constraints, the Constrain as the Same as Those Explained in Example 1.

### Example 4—How to Calculate Electrification Optimization

### Objective Function:

$${\sum }_{MGj = 1}^{N} {\sum }_{t = 1}^{T} ( MGj Power\_g - l ( t ) ) + MGj power\_g - ess ( t ) ) \times MGj elec - price ( t ) - ( Mgj power\_ess - g ( t ) + MGj power\_p v - g ) \times elec\_price ( t )$$

MGj Powerg-l (t) represent energy flow from grid (320) to a load (340) at specific period of time, t.

In some embodiments, the load is or comprises storage energy unit of TRAINi.
Decision variable: MGj Power_g-l (t), MGj power_g-ess (t), MGj power_ess-g (t), MGj power_ess-L (t), MGj power_pv-g (t), Gj power_pv-l (t) or Gj power pv-ess (t), including any combination thereof, for all i.
TRAINi constrain: reaching to each relevant MGi and charging

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination. All combinations of the embodiments pertaining to the invention are specifically embraced by the present invention and are disclosed herein just as if each and every combination was individually and explicitly disclosed. In addition, all sub-combinations of the various embodiments and elements thereof are also specifically embraced by the present invention and are disclosed herein just as if each and every such sub-combination was individually and explicitly disclosed herein.

Additional objects, advantages, and novel features of the present invention will become apparent to one ordinarily skilled in the art upon examination.

The above illustrates and describes basic principles, main features and advantages of the present invention. Those skilled in the art should appreciate that the above embodiments do not limit the present invention in any form. Technical solutions obtained by equivalent substitution or equivalent variations all fall within the scope of the present invention.

What is claimed is:

1. An electrification system configured to charge a rolling stock energy storage unit while in or passing through a charging segment infrastructure is characterized by:
a. segmental charging infrastructure for charging said energy storage unit of a rolling stock;
b. group or network of microgrids configured to supply electric power to at least one of said segmental charging infrastructure;
c. non-electrified segments;
d. energy-optimizing operating system (EO-OS) configured to optimize:
(i) operation of said segmental charging infrastructures;
(ii) operation of a group or network of microgrids having an at least one mutual constraint;
(iii) amount of energy transferred from said group or network of microgrids to an at least one storage energy unit;
(iv) energy arbitrage gain over geographic and time without using an electrical grid; and
(v) any combination thereof; and
e. processor configured to
(i) updating time-resolved data of energy supply constrains, rolling stock energy consumption, location and transport plan thereof; and
(ii) computing, optimizing the energy cost of the system, specifying the timetable, location, and schedules.

2. The electrification system of claim 1, wherein each microgrid of said group or network of microgrids supplies energy to a single segmental charging infrastructure.

3. The system of claim 1, wherein said each microgrid of said group or network of microgrids is located along said segmental charging infrastructure it supplies energy to.

4. The electrification system of claim 1, wherein each microgrid within said group or network of microgrids comprises dedicated power sources, non-dedicated power source, power loading, power capacity, and any combination thereof.

5. The electrification system of claim 1, wherein each microgrid within said group or network of microgrids is self-contained.

6. The electrification system of claim 1, wherein charging of said energy storage unit depends on amount of energy consumed, the distance to next segmental charging infrastructure, final destination, microgrid power availability, segmental charging infrastructure capability and energy storage unit charging rate including any combination thereof.

7. The system of claim 1, wherein said energy storage unit comprises electrical energy at any given time.

8. The electrification system of claim 1, wherein charging rate of said energy storage unit depends on
a. amount of electric power available at said microgrid;
b. segmental charging infrastructure capability to transfer energy; and
c. rolling stocks storage charging rate capabilities.

9. The electrification system of claim 1, wherein said energy storage unit is configured to supply electric energy to said rolling stocks while passing non-electrified segments.

10. The electrification system of claim 1, wherein said EO-OS comprises
a. Real-time energy supply constraints; Current and predictive locomotive energy consumption; Real-time location and transport plan information for each locomotive;
b. a wireless connection configured to send the energy plan to rolling stock, energy management system, microgrid, and any combination thereof;
c. a microgrid optimization energy flow optimization model;
d. a microgrid location optimization model; and
e. at least one database.

11. The electrification system of claim 1, wherein said EO-OS operates through online intercommunication between rolling stocks and said segmental charging infrastructure.

12. The electrification system of claim 1, wherein said processor further comprises a machine learning comprising
a. collecting updating time-resolved data related to energy consumption;
b. preprocessing of said collected data for analyzing, said preprocessing is selected from a group consisting of data cleaning, data transformation, data reeducation, data reduction, data quality assessment, and any combination thereof;
c. training a model for energy consumption, said model is an optimization model selected from a group consisting of linear programing, integer linear programming, mixed-integer linear programing, nonlinear programing, dynamic programing, quadratic programing, mixed quadratic programing, stochastic programming, and metaheuristic optimization algorithms, including any combination thereof;
d. validating thereby tunning hyperparameters, said hyperparameters are selected from a group consisting of speed profile, acceleration and deceleration rates, regenerative braking, train schedule and timetable, power management, train composition, weather conditions, and energy storage system, including any combination thereof; and
e. testing thereby evaluating said model performance.

13. The electrification system of claim 1, is further configured to transfer energy from one microgrid to another.

14. The electrification system of claim 13, wherein said transferred energy is sold to a grid.

15. The electrification system of claim 1, is renewable.

16. A method for producing an optimized microgrid plan configured to supply power to a rolling stock comprising:
a. at least one segmental charging infrastructure;
b. a group or network of microgrids configured to supply electric power to said at least one segmental charging infrastructure, said microgrids comprises at least one mutual constrain, a decision variable, and any combination thereof;
c. energy storage unit of said rolling stock;
d. an energy-optimizing operating system (EO-OS) configured to optimize:
(i) operation of said segmental charging infrastructures;
(ii) operation of a group or network of microgrids having an at least one mutual constraint;
(iii) amount of energy transferred from said group or network of microgrids to an at least one storage energy unit;
(iv) energy arbitrage gain over geographic and time without using an electrical grid; and
(v) any combination thereof,
wherein at any given moment energy within said energy storage unit is positive.

17. The method of claim 14, wherein said method minimizes levelized cost of energy.

18. The method of claim 14, wherein said optimized microgrid plan recommends:
a. where to position said group or network of microgrids;
b. where to position said segmental charging conductors; and
c. length of said segmental charging conductors.

19. A method for charging said at least one storage energy unit in said segmental charging infrastructure comprising
a. TRAINi having an energy storage unit;
b. a segmental charging infrastructure configured to charge the energy storge unit while it passes through or in the segmental infrastructure;
c. a group or network of self-maintain microgrids, MGj;
d. an un-electrified segment of the track;
e. an energy-optimizing operating system (EO-OS) configured to optimize:
(i) operation of said segmental charging infrastructures;
(ii) operation of a group or network of microgrids having an at least one mutual constraint;
(iii) amount of energy transferred from said group or network of microgrids to an at least one storage energy unit;
(iv) energy arbitrage gain over geographic and time without using an electrical grid; and
(v) any combination thereof; and
f. a processor;
wherein said energy storage unit comprises energy at any given time.

20. The method of claim 19, is further configured to transfer energy from one microgrid to another.
